(19) United States
(12) Patent Application Publication
(10) Pub. No.: US 2007/0174320 A1
(43) Pub. Date: Jul. 26, 2007

(54) Method and system for generating a concept-based keyword function, search engine applying the same, and method for calculating keyword correlation values

(75) Inventor: Peilin Chou, Taipei (TW)

Correspondence Address: PILLSBURY WINTHROP SHAW PITTMAN, LLP, P.O. BOX 10500, MCLEAN, VA, 22102, US

(73) Assignee: Bridgewell Incorporated, Taipei (TW)

(21) Appl. No.: 11/449,749

(22) Filed: Jun. 9, 2006

(30) Foreign Application Priority Data
Jan. 25, 2006 (TW) 095103005

(51) Int. Cl. G06F 7/00

(52) U.S. Cl. 707/101

(57) ABSTRACT

A search engine applying concept-based keyword functions involves the application of a keyword function that was generated by computing a keyword and that corresponds to and that represents concepts of the keyword. Contents of the keyword function can be adjusted through constant training with clicking actions of a user. A search conducted in the search engine based on the keyword function can locate information related to synonyms of the keyword, words related to the keyword, etc., thereby permitting a comprehensive and accurate web page data search.

### BACKGROUND OF THE INVENTION

1. Field of the Invention The invention relates to a method for processing data, more particularly to a method for generating a concept-based keyword function so as to enhance search efficiency.

2. Description of the Related Art

With advancements in digital networks and search tools, from the standpoint of a user, knowledge can be obtained with greater facility. For instance, the user can obtain the required knowledge through various portals (such as Yahoo®). The so-called portal is equivalent to a web encyclopedia that was compiled and classified by qualified personnel. The user can alternatively obtain the required knowledge through a search engine (such as Google®) which can be used to search databases on various web sites based on keywords. Therefore, when the user wants to learn something or acquire knowledge in a certain area, he/she can use the search engine to quickly obtain the required information. The emergence of the search engine has brought about breakthroughs in the Internet, and has fundamentally changed the way of learning and processing knowledge.

However, when the costs of learning and memorizing are considerably reduced, which represents a cost reduction in the generation and dissemination of knowledge, the amount of knowledge increases drastically, the quality of knowledge conversely drops, and the levels of knowledge tend to be complex and multi-directional. Even the search engines may not be able to easily and accurately help users to locate the required knowledge. A common scenario is that when a user wanting to know something about digital TV boxes, for instance, enters the keywords “digital TV box” in a search engine, the search engine may locate thousands of web advertisements and news pages based on the entered keywords for the user's selection. However, many websites or web pages that contain texts referring “digital TV box” as “digital set top box,” or “digital TV receiver” cannot be located by the search engine. In addition, other information (e.g., digital TV channels) that is highly relevant to “digital TV box” and that may be of interest to the user may not be located or may have a very low relevancy ranking. This is attributed to the technology adopted by current search engines in the ranking of search results based on the keywords entered by the user. Both the user and the web page designer are concerned about the ranking of the search results. In particular, the user wants the web pages that meet his/her needs to appear as top search results (a higher ranking), whereas the web page designer wants his/her web page to have a higher ranking of the search results in response to a specific keyword or a keyword string. Take the core software technology employed by the search engine Google® for ranking web pages as an example. The Google® search engine uses the huge link structure of the web as an indicator for adjusting/evaluating a web page's value. To put it simply, when web page A is linked to web page B, the search engine considers the link to be a vote by web page A for web page B. When many web pages or “important” web pages are linked to web page B, web page B will get a higher ranking and will become “important” web page data. Important and high-quality web sites will thus have a higher ranking. However, a setback of such search engine technology is that the search engine primarily relies on links between web pages. If a web page is not linked to other web pages, no matter how relevant the contents of the web page are to the query of the user, the search engine is unable to determine the degree of importance of the web page, and the web page may therefore have a very low ranking. Besides, if the located web pages do not meet the user's requirement, “important” web pages are meaningless to the user. Apart from the number of links which may affect the value of a web page, the heading or abstract of a web page also affects the value of the web page. For instance, if a hit keyword appears in the heading or abstract of a web page, the web page will have a higher ranking than if the hit keyword appears elsewhere in the web page. However, since the contents of the heading and the abstract are decided upon by the web page designer, the web page designer may add hot keywords, e.g., “music mp3 download,” which are irrelevant to the contents of the web page so as to increase the possibility of hit, thereby resulting in abusive addition of irrelevant keywords to the web pages. Under these circumstances, the user oftentimes may locate many irrelevant data when searching with a search engine. To improve the aforesaid situation, the user needs to improve his/her skill of using the search engines, i.e., the skill to enter proper keywords or to use various logic tools for conducting advanced searches. But this is contradictory to the spirit of scientific development.

In sum, a portal passively provides classified searches to allow the user to find the required information step by step with accuracy, as if looking up a dictionary. However, the process of going through different levels of classification hierarchy one after the other to obtain the required information takes up much time and effort. As for the search engines, they actively provide screened search results based on the entered keywords. However, due to the limitations of current technology, only when proper keywords are entered and the matching web pages are properly linked can the desired information be obtained. Therefore, those in the art are looking for a solution to the present problems and are finding a way to create a search engine with artificial intelligence.

### SUMMARY OF THE INVENTION

Therefore, an object of the present invention is to provide a method and system for generating a concept-based keyword function, in which a keyword can be used to generate an exclusive, corresponding keyword function that encompasses concepts related to the keyword.

Another object of the present invention is to provide a search engine that applies a concept-based keyword function so as to be capable of conducting a concept-based search.

Still another object of the present invention is to provide a method for calculating a correlation value for keywords to identify the degree of correlation between the keywords.

According to a first aspect of the present invention, a concept-based keyword function generating method of the present invention is adapted for generating an exclusive first keyword function for a first keyword. The method comprises:

(A) receiving results of a search through a web page database for a plurality of web pages relevant to the first keyword, each web page in the web page database being represented by a vector function including a plurality of keyword parameters and keyword weights corresponding thereto, and defining one of the keywords in one of the web pages relevant to the first keyword as a second keyword;

(B) confirming or classifying the web pages relevant to the first keyword as belonging to classes 1 to N;

(C) representing each of the first and second keywords with a classification function, each classification function including classification weights in the classes 1 to N;

(D) calculating a correlation value for the first and second keywords using the classification functions of the first and second keywords; and

(E) defining the first keyword function according to the second keyword and the correlation value obtained in step (D).

According to a second aspect of the present invention, a search engine applying a concept-based keyword function is adapted to conduct a search by primarily applying a first keyword function which was generated using a first keyword. The search engine comprises a web page database, a search module, a training module, a keyword function generating system, and a keyword function database.

The web page database includes a plurality of web pages. Each web page is represented by a vector function including a plurality of keyword parameters and keyword weights corresponding thereto. The search module searches the web page database for a plurality of web pages relevant to the first keyword or the first keyword function. The training module is capable of classifying the web pages in the web page database beforehand or classifying the web pages that were located by the search module to be relevant to the first keyword or the first keyword function into classes 1 to N. The keyword function database stores the first keyword function.

The keyword function generating system includes a computing module for performing the following tasks: defining a keyword in one of the web pages relevant to the first keyword as a second keyword; representing each of the first and second keywords with a classification function, each classification function including classification weights in the classes 1 to N; calculating a correlation value for the first and second keywords using the classification functions of the first and second keywords; and defining or re-defining the first keyword function based on the second keyword and the correlation value.

According to a third aspect of the present invention, a method for calculating a keyword correlation value is adapted to calculate a degree of correlation between first and second keywords appearing in a plurality of web pages. The method comprises:

(a)confirming or classifying the web pages to be belonging to classes 1 to N;

(b) representing each of the first and second keywords with a classification function, each classification function including classification weights in the classes 1 to N; and

(c) calculating a correlation value for the first and second keywords using the classification functions of the first and second keywords.

### BRIEF DESCRIPTION OF THE DRAWINGS

Other features and advantages of the present invention will become apparent in the following detailed description of the preferred embodiments with reference to the accompanying drawings, of which:

FIG. 1 is a block diagram of the first preferred embodiment of a search engine according to the present invention;

FIG. 2 is a flowchart to illustrate a method for generating a keyword function in the first preferred embodiment;

FIG. 3 is a schematic diagram to illustrate the method of generating the keyword function;

FIG. 4 is a flowchart to illustrate the operation of the search engine;

FIG. 5 is a block diagram of the second preferred embodiment of a search engine according to the present invention; and

FIG. 6 is a flowchart to illustrate the operation of the second preferred embodiment of the search engine according to the present invention.

### DETAILED DESCRIPTION OF THE PREFERRED EMBODIMENTS

Before the present invention is described in greater detail, it should be noted that like elements are denoted by the same reference numerals throughout the disclosure.

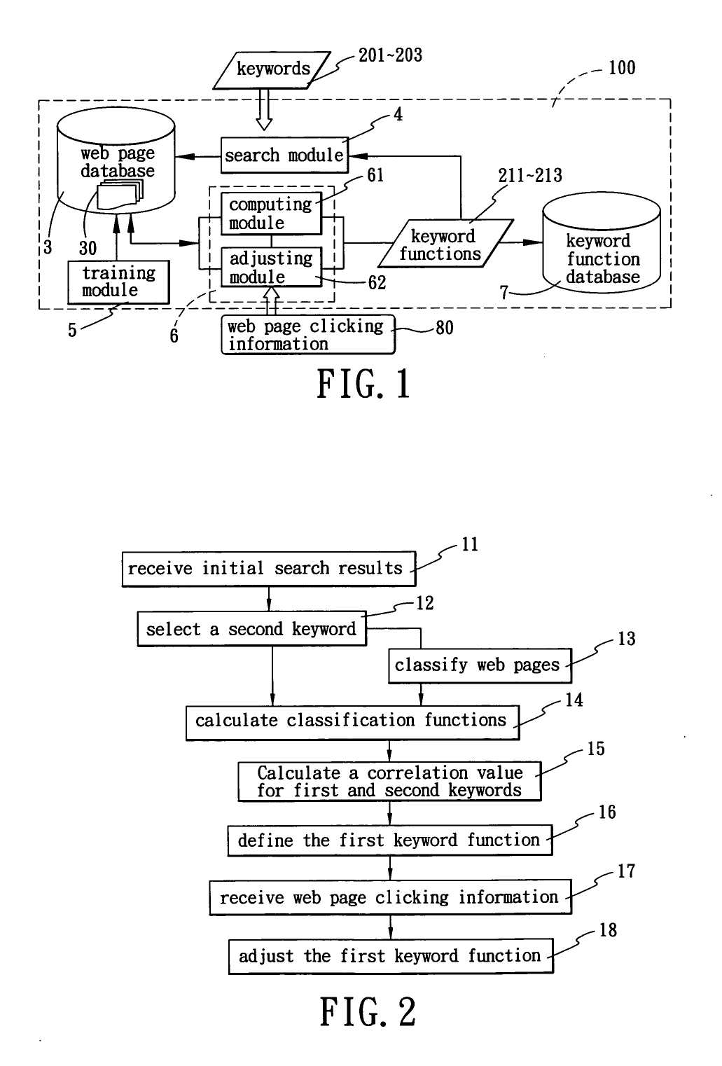

As shown in FIG. 1, the first preferred embodiment of a search engine 100 applying a concept-based keyword function according to the present invention is characterized in the application of a keyword function (first to third keyword functions 211-213 in the following example) that is generated by computing keywords (this embodiment is exemplified using first to third keywords 201-203), that corresponds to the keywords, and that represents concepts of the keywords. Contents of the keyword function can be constantly adjusted for conducting an accurate and thorough web page data search. The search engine 100 includes a web page database 3, a search module 4, a training module 5, a keyword function generating system 6, and a keyword function database 7. The keyword function generating system 6 includes a computing module 61 and an adjusting module 62. The web page database 3 has a plurality of web pages 30 stored therein. Each web page 30 is represented by a vector function P including a plurality of keyword parameters I and keyword weights W corresponding thereto, as shown in the following equation (1)

P=(I_{P1}, W_{P1}),(I_{P2}, W_{P2}),(I_{P3}, WP₃) equation 1

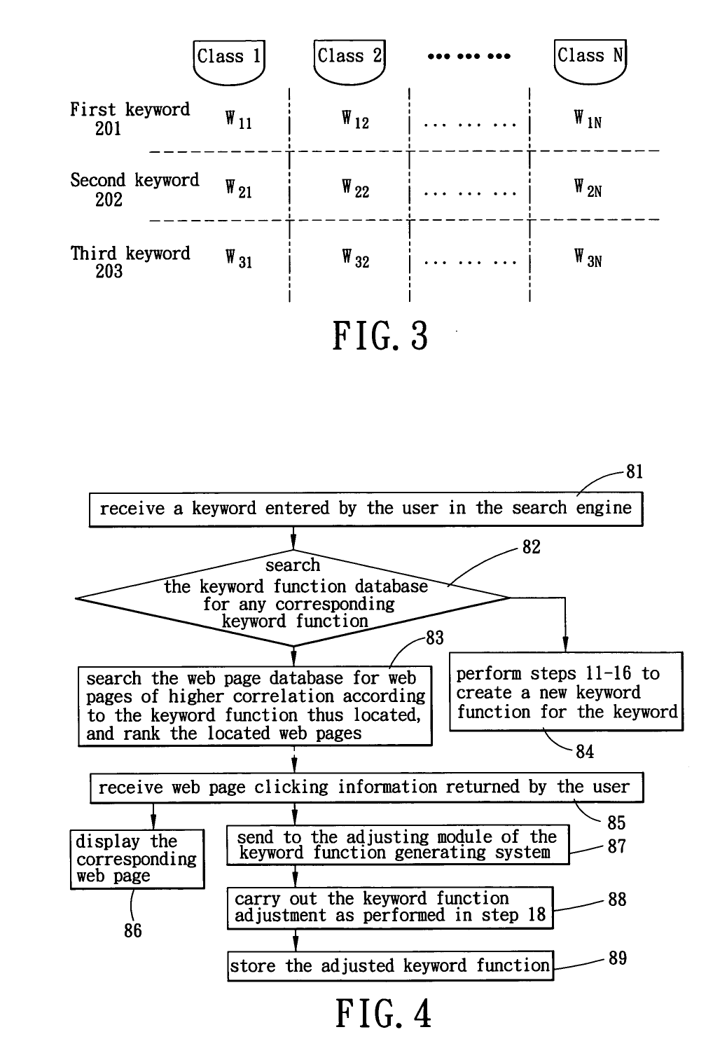

With further reference to FIGS. 2 and 3, the search engine 100 will be described hereinbelow in a comprehensive manner, focusing on a keyword function generating method in which computation is mainly carried out by the keyword function generating system 6.

This embodiment is exemplified on the basis that a first keyword function 211 is generated exclusively for a first keyword 201. In the following calculation process, the correlation between the first keyword 201 and the second keyword 202 is first calculated to serve as a basis, and the correlation between the first keyword 201 and the third keyword 203 is calculated to serve as a reference to facilitate understanding. The keyword function database 7 is finally constructed for searching by the search engine 100. The following steps 11-16 are performed by the computing module 61 of the keyword function generating system 6, whereas the following steps 17-18 are performed by the adjusting module 62.

In step 11, initial search results are received. It is assumed in this embodiment that a keyword function corresponding to the first keyword 201 has yet to be constructed in this step. Therefore, the search module 4 of the search engine 100 can only search for web pages, documents, and various files matching the first keyword 201 from the web page database 3, and only web pages are exemplified herein. It is noted that this step may be carried out in a situation where the keyword 201 already has a corresponding keyword function 211, and the search for relevant web pages is conducted through the web page database 3 based on the first keyword function 211. Alternatively, the first keyword function can be pre-determined using a concept-based word bank to serve as an initial setting value. The aforesaid concept-based word bank is equivalent to an advertisement database provided by an advertiser or carrier as described in Taiwanese patent application no. 094136628.

In step 12, the second keyword 202 is selected. Supposing the search results obtained in step 11 include a plurality of web pages related to the first keyword 201, one of the keywords in the web pages thus found is defined as the second keyword 202.

In step 13, the web pages 30 are classified. This invention can be used to classify all the web pages 30 in the web page database 3 beforehand. Alternatively, only the web pages 30 that are relevant to the first keyword 201 as obtained in step 11 are classified. A classification scheme is to automatically allocate the web pages 30 to classes 1 to N according to the contents of the web pages 30 through use of a learning algorithm mechanism.

In step 14, classification functions are calculated. The first and second keywords 201, 202 are respectively represented by classification functions in the following equations 2 and 3. Each classification function includes classification weights W in the classes 1 to N.

V₁=(W₁₁, W₁₂, W₁₃, . . . W_{1N}) equation 2

V₂=(W₂₁, W₂₂, W₂₃, . . . W_{2N}) equation 3

The aforesaid classification weight W represents the probability of the first or second keyword in the web pages of a class, which may be a term frequency, a document frequency, or a normalized frequency. The term frequency is a measure of how often a term appears in a document. A higher frequency indicates that the term has greater importance in the contents of the document. The document frequency is a measure of how often a term appears in the entire database. Since insignificant words like prepositions and conjunctions appear most frequently in the entire database, if a term has a low document frequency, this means that the term has more importance. The normalized frequency is a frequency value obtained from linear or non-linear normalization of the various probabilities mentioned hereinabove.

In step 15, a correlation value for the first and second keywords 201, 202 is calculated. By using the classification functions of the first and second keywords 201, 202 obtained in step 14, and through calculating the correlation value or a function distance for the classification functions V₁, V₂, a correlation value exclusive to the first and second keywords 201, 202 can be obtained.

It is noted that the aforesaid steps 12-15 are steps of calculating the correlation values of the keywords. Once the correlation between the keywords is found, it not only can be used to generate keyword functions, it can also be used for purposes of classification, extracting passages from documents, etc.

In step 16, the first keyword function 211 is defined. According to the second keyword 202 and the correlation value obtained in step 15, a very simple initial first keyword function 211 can be obtained: K₁=(K₂, C₁₂). Certainly, there may not only be the second keyword 202 that is correlated to the first keyword 201 or that may affect the first keyword function 211. The underlying principle for calculating the second keyword, the third keyword, . . . the Mth keyword is the same. The finally obtained first keyword function 211 is expressed in the following equation 4, where K₁, K₂, K₃˜K_{M} respectively represent first to Mth keyword parameters; C₁₂ is the correlation value for V₁, V₂ (representing the first and second keywords 201, 202); C₁₃ is the correlation value for V₁, V₃ (representing the first and third keywords); and C_{1M} is the correlation value for V₁, V_{M} (representing the first and Mth keywords).

K₁=(K₂,C₁₂),(K₃,C₁₃), . . . (K_{M}, C_{1M}) equation 4

If the keyword 201 already has a corresponding keyword function 211 in step 11, the aforesaid steps 12 to 16 are substantially equivalent to redefining the first keyword function 211. Finally, the keyword functions are stored in the keyword function database 7.

Instep 17, web page clicking information associated with clicking a web page is received. This indicates that, among the search results based on the first keyword 201, the user is interested in the contents of the clicked web page. This also indicates that the web page meets the requirement of the user. Therefore, the keyword in the clicked web page should have an effect on the first keyword function 211.

In step 18, the first keyword function 211 is adjusted. Through a data training scheme, and according to the correlation between the clicked web page and the first keyword function 211, the clicked web page is automatically determined and classified, and the first keyword function 211 is adjusted. The first keyword function 211 can be regarded as a classifier, or a hyper plane that divides the web page data in a multi-dimensional space constituted by the web pages 30 in the web page database 3, and that automatically determines and classifies the relevant web pages through a data training scheme.

In the same manner, with respect to the third keyword 203, the correlation value for the first and third keywords 201, 203 can be calculated to cast an effect on the first keyword function 211.

Referring to both FIGS. 1 and 4, the operational steps of the search engine 100 that applies the concept-based keyword functions in this embodiment includes:

In step 81, a keyword entered by the user in the search engine 100 is received.

In step 82, the keyword function database is searched to locate any corresponding keyword function.

In step 83, if yes, the webpage database 3 is searched for web pages 30 of higher correlation according to the keyword function thus located, and the web pages 30 are ranked in order of the degree of correlation between the keyword function and the web page vector function p.

In step 84, if no, steps 11-16 of FIG. 2 are performed to create a new keyword function for the keyword.

In step 85, webpage clicking information 80 returned by the user is received.

In step 86, the corresponding web page is displayed.

In step 87, the web page clicking information 80 is sent to the adjusting module 62 of the keyword function generating system 6 concurrently with the execution of step 86.

In step 88, adjustment of the keyword function as performed in the aforesaid step 18 of FIG. 2 is carried out.

In step 89, the keyword function thus adjusted is stored in the keyword function database 7.

In the prior art, only information that completely matches the keyword will be located, and the ranking of the web pages is not necessarily relevant to the degree of correlation between the keyword and the contents of the web pages. However, in the present invention, exclusive keyword functions are constructed for keywords based on the correlation with other keywords, and learning and/or training of the functions are performed based on the clicking actions of the user. A search in a search engine based on the keyword functions can cover all the relevant information, including synonyms, related words, etc.

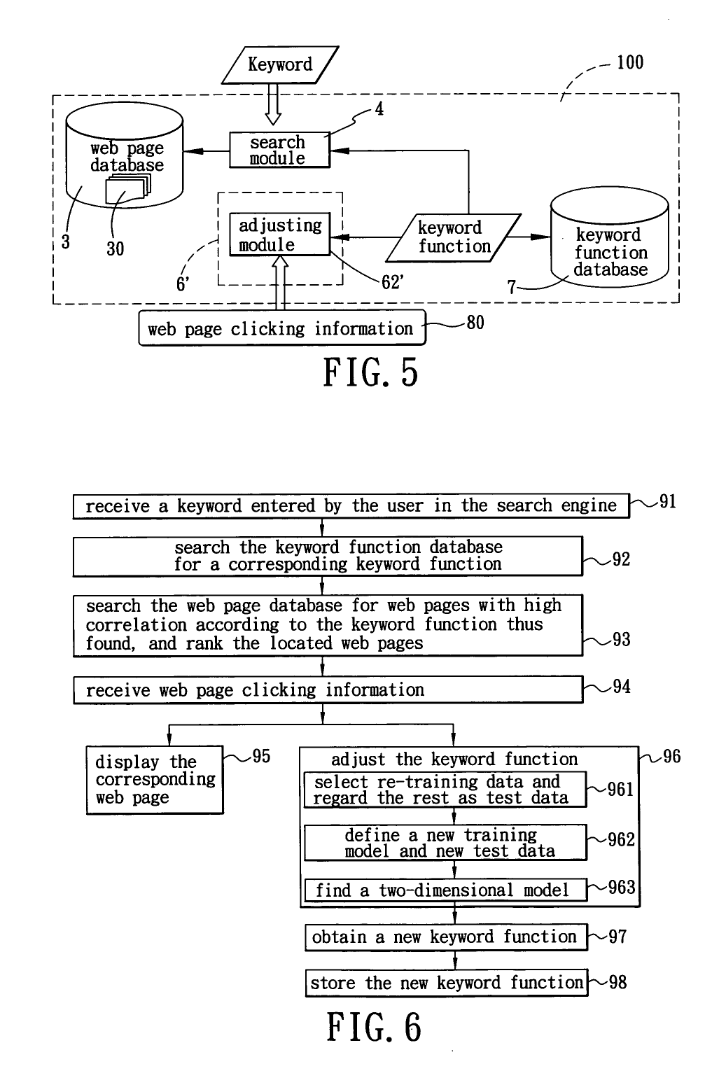

Referring to FIGS. 5 and 6, the second preferred embodiment of a search engine 100 applying the concept-based keyword function according to the present invention differs from the first preferred embodiment in that this embodiment primarily uses the keyword function adjusted by the adjusting module 62′ of the keyword function generating system 6′ (steps 17 and 18 of FIG. 2) for searching, and does not necessarily require the use of the computing module 61 (steps 11-16 of FIG. 2) to generate a keyword function.

The search engine 100 of this embodiment likewise includes the web page database 3, the search module 4, and the keyword function database 7, but does not have the training module 5 associated with the web page database 3. Besides, the keyword function generating system 6′ only includes the adjusting module 62′. The adjusting module 62′ has the function of training via the web pages clicked by the user.

The steps performed by the search engine 100 of this embodiment are as follows.

Instep 91, a keyword entered by the user in the search engine 100 is received.

In step 92, according to the keyword entered by the user, a corresponding keyword function is found from the keyword function database 7.

In step 93, the web page database 3 is searched for web pages 30 with high correlation according to the keyword function thus found, and the located web pages 30 are arranged in order of degree of correlation between the keyword function and the web page vector function P.

In step 94, web page clicking information associated with clicking a web page 30 in the web page database 3 is received from the user.

In step 95, the corresponding web page 30 is displayed.

In step 96, through a data training scheme and according to the correlation between the clicked web page and the keyword function, determination and classification of the clicked web page and adjustment of the keyword function are automatically performed. The data training scheme may be realized via a data processing technique such as a neural network, Naive Bayes, Support vector machines (SVM), etc. This embodiment provides another alternative technique, and step 96 includes the following sub-steps.

In step 961, learning results that are extremely stable and learning results that are extremely unstable are selected from the web page that has been clicked to serve as re-training data, and the rest are regarded as test data.

In step 962, the re-training data and the clicked web page are combined to define a new training model, and the test data and the clicked web page are combined to define new test data.

In step 963, a correlation between the keyword function and the new test data and a correlation between the new training model and the new test data are found to obtain a two-dimensional model.

In step 97, with the correlation between the keyword function and the new test data serving as a weight of the keyword function, and with the correlation between the new training model and the new test data serving as a weight of the new training model, the weights are combined to obtain a new keyword function representing new learning results.

In step 98, the new keyword function is stored in the keyword function database 7.

In sum, the present invention integrates the strength of classified searches provided by a portal into the search engine so as to automatically supply comprehensive and accurate concept-based information to thereby result in a search engine having artificial intelligence. The objects of the present invention are thus achieved.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A concept-based keyword function generating method for generating an exclusive first keyword function for a first keyword, said method comprising:
(A) receiving results of a search through a web page database for a plurality of web pages relevant to the first keyword, each web page in the web page database being represented by a vector function including a plurality of keyword parameters and keyword weights corresponding thereto, and defining one of the keywords in one of the web pages relevant to the first keyword as a second keyword;
(B) confirming or classifying the web pages relevant to the first keyword as belonging to classes 1 to N;
(C) representing each of the first and second keywords with a classification function, each classification function including classification weights in the classes 1 to N;
(D) calculating a correlation value for the first and second keywords using the classification functions of the first and second keywords; and
(E) defining the first keyword function according to the second keyword and the correlation value obtained in step (D).

2. The method according to claim 1, wherein, in step (D), the correlation value for the first and second keywords is obtained by calculating one of a correlation and a distance between the classification functions thereof.

3. The method according to claim 1, wherein the classification weights in step (C) represent the probabilities of the respective keyword in the web pages of one of he classes 1 to N.

4. The method according to claim 3, wherein the classification weight is one of a term frequency, a document frequency, and a normalized frequency.

5. The method according to claim 1, wherein the web pages are automatically classified through a learning algorithm mechanism in step (B).

6. The method according to claim 1, further comprising a step (F), which includes the sub-steps of: (F1) receiving web page clicking information associated with clicking a web page; and, (F2) through a data training scheme and according to the correlation between the clicked web page and the first keyword function, automatically determining and classifying the clicked web page and adjusting the first keyword function.

7. The method according to claim 1, wherein, in step (A), the web page database is searched to locate the relevant web pages based on an existing first keyword function.

8. The method according to claim 7, wherein an initial setting of the existing first keyword function is predetermined using a concept-based word bank.

9. A keyword function generating system which is operable in conjunction with a web page database, a training module, and a search module to generate an exclusive first keyword function for a first keyword, each page in the web page database being represented by a vector function including a plurality of keyword parameters and keyword weights corresponding thereto, the search module searching the web page database for a plurality of web pages relevant to the first keyword, the web pages being subjected to data training by the training module prior to or after being located so as to be automatically classified into classes 1 to N, said keyword function generating system comprising: a computing module for performing the following tasks: defining one of keywords in one of the web pages relevant to the first keyword as a second keyword; representing each of the first and second keywords with a classification function, each classification function including classification weights in the classes 1 to N; calculating a correlation value for the first and second keywords using the classification functions of the first and second keywords; and defining the first keyword function using the second keyword and the correlation value.

10. The keyword function generating system according to claim 9, wherein said computing module calculates the correlation value for the first and second keywords by calculating one of a correlation and a distance between the classification functions thereof.

11. The keyword function generating system according to claim 9, wherein the classification weight in the classification function represents the probability of the respective keyword in the web pages of one of the classes 1 to N, and is one of a term frequency, a document frequency, and a normalized frequency.

12. The keyword function generating system according to claim 9, further comprising an adjusting module which receives web page clicking information associated with clicking a web page and which, through a data training scheme and according to correlation between the clicked web page and the first keyword function, automatically determines and classifies the clicked web page and adjusts the first keyword function.

13. A search engine applying a concept-based keyword function, said search engine being adapted to conduct a search by primarily applying a first keyword function which was generated using a first keyword, said search engine comprising:
a web page data base including a plurality of web pages, each web page being represented by a vector function including a plurality of keyword parameters and keyword weights corresponding thereto;
a search module for searching the web page database for a plurality of web pages relevant to one of the first keyword and the first keyword function;
a training module capable of classifying the web pages in the web page database beforehand or classifying the web pages that were located by the search module to be relevant to said one of the first keyword and the first keyword function into classes 1 to N;
a keyword function generating system including a computing module for performing the following tasks: defining a keyword in one of the web pages relevant to the first keyword as a second keyword; representing each of the first and second keywords with a classification function, each classification function including classification weights in the classes 1 to N; calculating a correlation value for the first and second keywords using the classification functions of the first and second keywords; and defining or re-defining the first keyword function based on the second keyword and the correlation value; and
a keyword function database for storing the first keyword function.

14. The search engine according to claim 13, wherein said computing module of said keyword function generating system calculates the correlation value for the first and second keywords by calculating one of a correlation and a distance between the classification functions thereof.

15. The search engine according to claim 13, wherein the classification weight in the classification function represents the probability of the respective keyword in the web pages of one of the classes 1 to N, and is one of a term frequency, a document frequency, and a normalized frequency.

16. The search engine according to claim 13, wherein said keyword function generating system further includes an adjusting module for receiving web page clicking information associated with clicking a web page, and, through a data training scheme, for automatically determining and classifying the clicked web page and adjusting the first keyword function according to a correlation between the clicked web page and the first keyword function.

17. The search engine according to claim 13, wherein said search module searches relevant web pages in said web page database based on an existing first keyword function, an initial setting of the existing first keyword function being predetermined using a human-compiled concept-based word bank.

18. A method for calculating a keyword correlation value, which is adapted to calculate a degree of correlation between first and second keywords appearing in a plurality of web pages, said method comprising:
(a) confirming or classifying the web pages to be belonging to classes 1 to N;
(b) representing each of the first and second keywords with a classification function, each classification function including classification weights in the classes 1 to N; and
(c) calculating a correlation value for the first and second keywords using the classification functions of the first and second keywords.

19. The method according to claim 18, wherein, in step (c), the correlation value for the first and second keywords is calculated by calculating one of a correlation and a distance between the classification functions thereof.

20. The method according to claim 18, wherein the classification weights in step (b) represent the probabilities of the respective keyword in the web pages of one of the classes 1 to N.

21. The method according to claim 20, wherein the classification weight is one of a term frequency, a document frequency, and a normalized frequency.

22. The method according to claim 18, wherein, in step (a), the web pages are automatically classified according to contents of the web pages through a learning algorithm mechanism.
